(19) United States
(12) Patent Application Publication
(10) Pub. No.: US 2023/0378572 A1
(43) Pub. Date: Nov. 23, 2023

(54) PHOTO RECHARGEABLE ELECTROCHEMICAL ENERGY STORAGE DEVICE

(71) Applicant: THE REGENTS OF THE UNIVERSITY OF CALIFORNIA, Okland, CA (US)

(72) Inventors: Taehoon Lim, Riverside, CA (US); Seungjin Lee, Riverside, CA (US); Alfredo A. Martinez-Morales, Riverside, CA (US)

(73) Assignee: THE REGENTS OF THE UNIVERSITY OF CALIFORNIA, Okland, CA (US)

(21) Appl. No.: 18/248,377

(22) PCT Filed: Oct. 8, 2021
(86) PCT No.: PCT/US2021/054253

§ 371 Date: Apr. 7, 2023

Related U.S. Application Data
(60) Provisional application No. 63/089,196, filed on Oct. 8, 2020.

(51) Int. Cl. H01M 14/00; H01M 10/46; H01M 4/131; H01M 4/1391; H01M 4/04; H01M 10/0568

(52) U.S. Cl. CPC H01M 14/005; H01M 10/465; H01M 4/131; H01M 4/1391; H01M 4/0404; H01M 10/0568; H01M 2300/0028; H01M 2004/027

(57) ABSTRACT

A photo rechargeable electrochemical energy storage device, a power generation device, and a method for fabricating the photo rechargeable electrochemical energy storage device in a mostly unrestricted atmospheric environment are disclosed. The power generation device including a rechargeable electrochemical energy storage device including a photoanode arranged beneath a transparent electrode, the photoanode comprising an oxide of titanium; and a micro-power conversion controller configured to control delivery of power under load, and recharge the rechargeable electrochemical energy storage device when not under rated load and when the transparent electrode is exposed to sufficient light and/or grid power is available.

### TECHNICAL FIELD

The present disclosure generally relates to a rechargeable electrochemical energy storage device, for example, a photo rechargeable battery or photo boosting charging device, and more particularly, to a metal ion solar battery (MISB) or proton solar battery (PSB), a power generation device with integrated energy storage functionality, and a method for fabrication of a rechargeable electrochemical energy storage device.

### BACKGROUND

Solar energy is one of the most promising renewable energy sources in terms of being pollution-free and with an unlimited energy source. Solar photovoltaic (PV) cells convert solar radiant energy into electricity. Unfortunately, energy generation is highly dependent on the time of the day, time of the year, environmental conditions, and local environmental parameters. For example, solar energy is limited by the diurnal cycle and can be highly susceptible to weather conditions.

In order to add further value to solar photovoltaic systems, photovoltaic panels can be combined with energy storage systems such as batteries to improve the reliability and dispatchability of solar energy systems. However, the connection of separate system components causes significant energy losses with solar photovoltaic systems having an overall system efficiency of about 78% and Li-ion battery energy storage systems having a round trip efficiency of about 84%. Furthermore, the integration of solar photovoltaic systems with batteries requires both a battery management system (BMS) and an energy management system (EMS) that are responsible for managing the utilization of solar production, energy storage, and power to the loads. The battery management system (BMS) and the energy management system (EMS) can complicate the overall architecture of the solar photovoltaic plus battery system, as well as the operation and maintenance requirements.

### SUMMARY

In consideration of the above issues, it would be desirable to have a rechargeable electrochemical energy storage device, for example, a photo-rechargeable battery, which includes a Li-ion battery with functionality of solar energy generation, or alternatively, a solar PV cell with functionality of battery energy storage. In addition, the combination of solar production and energy storage in a single solar battery device can provide significant benefits in applications that require renewable energy and energy storage capabilities, by simplifying the system architecture and minimizing energy losses.

In accordance with an aspect, a rechargeable electrochemical energy storage device, the storage device comprising: a photoanode.

In accordance with another aspect, a rechargeable electrochemical energy storage device, the storage device comprising: a photoanode made of a material selected from a group consisting of TiO₂ or other photocatalyst materials comprising: metal oxides, metal nitrides, metal sulfides, metal sulphates, metal phosphates, metal oxynitrides, and metal oxysulfides in which the metals are chosen from B, Mg, Al, Si, Ca, Sc, Ti, V, Cr, Mn, Fe, Co, Ni, Cu, Zn, Ga, Ge, As, Sr, Y, Zr, Nb, Mo, Tc, Ru, Rh, Pd, Ag, Cd, In, Sn, Sb, Te, Ba, La, Hf, Ta, W, Re, Os, Ir, Pt, Au, Hg, Ti, Pb, Bi, Po; III-V semiconductors where group III is B, Al, Ga, In and V is N, P, As, Sb; II-VI semiconductors where group II is Zn, Cd, Hg and VI is Se and Te; Group IV semiconductors which C, Si, Ge, Sn and their combinations; Group VI semiconductors which S, Se, Te and their combinations; and/or perovskite (M₁M₂Oₓ) where M₁ is Na, Sr, Ba, K, Li, Re, La, Pb, Ca, Rb, Cs, Pd, Bi, Y, Mg, and M₂ is Ti, V, Cr, Fe, Mn, Cu, Co, Ag, Ni, Ta, Nb, W, Mo, Re, and Zr.

In accordance with an aspect, a power generation device comprising: a rechargeable electrochemical energy storage device including a photoanode arranged beneath a transparent electrode; and a micro-power conversion controller configured to control delivery of power under rated load, and recharge the rechargeable electrochemical energy storage device and when the transparent electrode is exposed to sufficient light and/or grid power is available.

In accordance with another aspect, a method is disclosed for fabrication of a rechargeable electrochemical energy storage device in a mostly unrestricted atmospheric environment, the method comprising: fabricating a photoanode from a photocatalytic material, wherein the photocatalytic material is titanium dioxide (TiO₂); depositing the photoanode on a transparent electrode; fabricating a cathode and depositing the cathode on an electrode, the cathode being made of LiFePO₄; sandwiching the photoanode and the cathode together with a space between the photoanode and the cathode; and injecting an electrolyte into the space between the photoanode and the cathode inside a glovebox, the electrolyte being a lithium salt in an organic solvent, for example, lithium bis(oxalato)borate (LiBOB) in propylene carbonate (PC) or lithium bis(trifluoromethanesulfonyl)imide (LiTFSI) in propylene carbonate (PC).

### BRIEF DESCRIPTION OF THE DRAWINGS

FIG. 1 is an illustration of a structure of a rechargeable electrochemical energy storage device, for example, a metal ion solar battery (MISB) or proton solar battery (PSB) in accordance with an exemplary embodiment.

FIG. 2 is an illustration of an exemplary embodiment of a fabrication process mostly in an unrestricted atmospheric environment for the metal ion solar battery (MISB) or proton solar battery (PSB).

FIG. 3 is a schematic diagram of the charging of the metal ion solar battery (MISB) in accordance with an exemplary embodiment.

FIG. 4 is a schematic diagram of the discharging of the metal ion solar battery (MISB) in accordance with an exemplary embodiment.

FIG. 5 is a chart illustrating the photovoltaic I-V or solar cell characteristics of the metal ion solar battery (MISB) in accordance with an exemplary embodiment.

FIGS. 6A-6C are charts illustrating charging/discharging profiles for the metal ion solar battery (MISB) under different charging methods in accordance with an exemplary embodiment.

FIG. 7 is a chart illustrating the cyclic voltammogram of the metal ion solar battery (MISB) under dark and illuminated conditions.

FIG. 8 is an illustration of a power generation device in accordance with an exemplary embodiment.

FIG. 9 is a flow chart illustrating a fabrication process for the metal ion solar battery (MISB) in accordance with an exemplary embodiment.

FIG. 10 is an illustration of another fabrication process in a partially unrestricted atmospheric environment in accordance with an exemplary embodiment.

FIG. 11 is an illustration of another fabrication process in a partially unrestricted atmospheric environment in accordance with an exemplary embodiment.

FIG. 12 is an illustration of the solar battery and use in accordance with an exemplary embodiment.

### DETAILED DESCRIPTION

Reference will now be made in detail to the present preferred embodiments of the disclosure, examples of which are illustrated in the accompanying drawings. Wherever possible, the same reference numbers are used in the drawings and the description to refer to the same or like parts.

In accordance with an exemplary embodiment, an energy storage device is disclosed that due to its elegant architecture and selection of material layers exhibits properties of a solar cell device, and is capable of charging the integrated battery via the photovoltaic effect. In contrast to existing systems that are not true photo-rechargeable batteries since they do not solve the fundamental problems inherent to the traditional architecture of solar power generation and storage systems, an energy storage device is disclosed that exhibits true solar cell and battery characteristics simultaneously, and the complementary architecture and characteristics overcome disadvantages of traditional systems. For example, the mismatch between power generation and electrical load. In addition, because the disclosed energy storage system has the functionality of energy storage within the device, electric power can be released on demand, even during the nighttime.

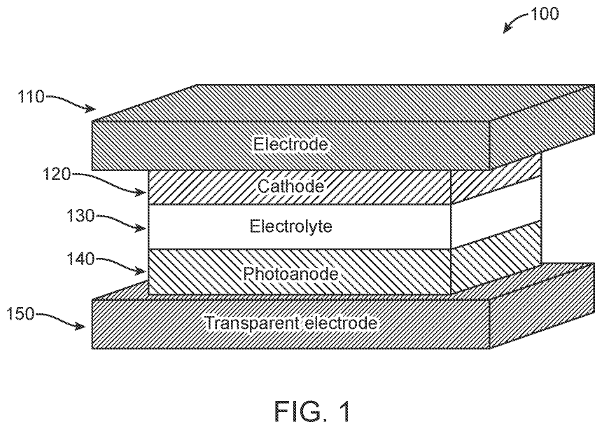

In accordance with an exemplary embodiment, the energy storage system is a metal ion solar battery (MISB) or proton solar battery (PSB) that is an elegant and seamlessly integrated solar cell and battery system in one device. Solar photovoltaic (PV) systems generally require an energy storage system for providing controllable, stable, and dispatchable energy. The traditional solar-plus-battery systems externally connect these two individual systems as a single architecture at the system level. Approaches to achieve an integrated structure of the solar-plus-battery is mostly done via a tandem structure, which stacks together a solar cell and battery using 3 electrodes (one in the middle between the solar cell and battery, and two on each side). In accordance with an exemplary embodiment, the disclosed MISB or PSB architecture is an advancement towards achieving true integration of a solar cell with a battery integrated at the device level, which is achieved by using a dual-functioning photoelectrode and a charge recombination blocking layer which allows energy storage inside the solar cell device with a 2-electrode structure as shown in FIG. 1. In accordance with an exemplary embodiment, the MISB or PSB can achieve true device-level energy storage.

As shown in FIG. 1, the metal ion solar battery (MISB) or proton solar battery (PSB) 100 includes, for example, an electrode 110, a cathode 120, an electrolyte 130, a photoanode 140, and a transparent electrode 150.

### Fabrication Process for Solar Charging Battery

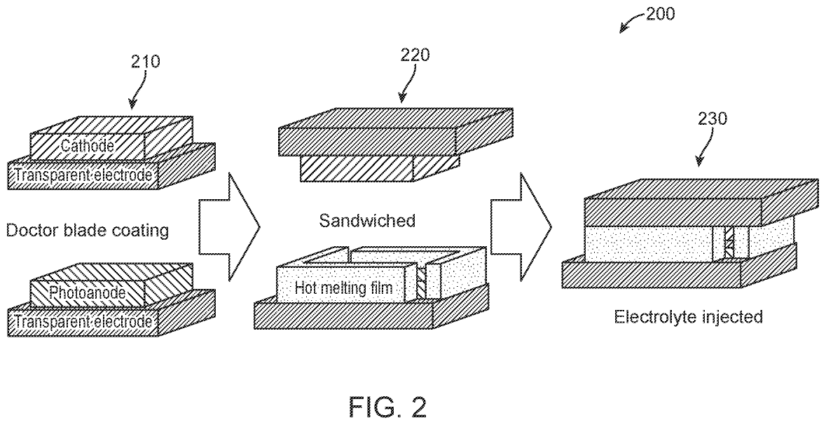

While other approaches require an oxygen-free and moisture-free environment or high-level vacuum, in accordance with an exemplary embodiment, the metal solar ion battery (MISB) can be fabricated through a relatively cost-effective doctor blading (or screen-printing) process under mostly unrestricted atmospheric environment (e.g. open air environment) as shown in FIG. 2. In accordance with an exemplary embodiment, the fabrication process for the energy storage device is described as follows.

In accordance with an exemplary embodiment, the photoanode 140 is a photocatalytic material, for example, titanium dioxide (TiO₂). In addition, for example, the crystal structure, morphology, and physical dimension of TiO₂ can be adjusted as desired. In accordance with an exemplary embodiment, anatase, rutile, brookite, amorphous, and any other crystal structure of TiO₂ and their mixture can be used to fabricate the photoanode. In addition, stacked nanoparticles, hollow-shell structures, nanowires, nanorods, thin-films and/or any other morphology can be used for the photoanode.

In accordance with an exemplary embodiment, the TiO₂ material (photoanode) 140 is deposited on the transparent electrode 150, for example, an indium-doped tin oxide (ITO), fluorine-doped tin oxide (FTO), or other transparent conducting film via direct crystal growth or slurry coating from the mixture of TiO₂ nanocrystals and a binding polymer. For example, the TiO₂ material can be a paste containing 17% wt %-20% wt % TiO₂, less than 10% binding polymer, and the balance being a solvent (e.g., i.e. α-terpineol). Carbon-based materials such as carbon black, graphite, graphene, and amorphous carbon can also be added to the slurry. In accordance with an exemplary embodiment, the TiO₂ can be 15 wt % to 50 wt %, less than 15 wt % binding polymer, and the balance being solvent (e.g. N-methylpyrrolidinone (NMP)). In addition, the binding polymer for preparation of the electrodes (cathode and anode) for the Li-ion battery chemistry can include polyvinylidne fluoride (PVDF), styrene-butadiene rubber (SBR), and carboxymethyl cellulose (CMC). In accordance with an exemplary embodiment, for example, the active material (e.g., LiFePO₄, TiO₂) can be 27.2 wt % to 32.64 wt %, carbon conductive material (e.g. super P) can be 0.68 wt % to 3.4 wt %, and the binding polymer (e.g., PVDF) can be 0.68 wt % to 3.4 wt %. For example, the active material, the carbon conductive material, and the binding polymer can be approximately 34 wt % and the solvent (e.g. NMP) can be approximately 66 wt %.

In accordance with an exemplary embodiment, the cathode 120 can be made of the LiMOₓ, which can be a generic cathode material for Li-ion battery such LiFePO₄, or LiCoO₂. LiMOₓ being the generalized chemical formula for lithium metal oxide (LMO), where M can be a metal element (e.g. Co, Fe, Ni, Zn, Cu). The ‘x’ represents the oxygen content. Examples of LMO can include, for example, LiCOO₂, LiFeO₂, LiNiO₂, LiZnO₂, and LiCuO₂. The cathode can be deposited by slurry coating on a regular electrode (e.g. does not need to be transparent). For example, this step may be similar to the fabrication process of a generic coin-cell Li-ion battery. The crystallinity and mechanical strength of the cathode can be improved by thermal treatment. After the two electrodes, (i.e., the photoanode and the cathode) are prepared, the photoanode and the cathode are sandwiched and an electrolyte is injected between the two electrodes, for example, inside a glovebox. For example, the device can be sealed before the electrolyte is injected to help prevent the electrolyte from leaking out. Once injected, the electrolyte maintains a close contact with the two electrodes due to the surface tension of the solution (or capillary force). In accordance with an exemplary embodiment, for example, in the case of a MISB based on lithium-ion, the electrolyte has Li⁺ as the main charge carrier. For example, a highly concentrated Li⁺ solution such as a lithium salt in organic solvent, for example, lithium bis(oxalato)borate (LiBOB) in propylene carbonate (PC) or lithium bis(trifluoromethanesulfonyl)imide (LiTFSI) in propylene carbonate (PC) can be used.

In accordance with an exemplary embodiment, a metal ion solar battery (MISB) or proton solar battery (PSB) is disclosed, which includes a photoanode made of a material selected from a group consisting of TiO₂ or other photocatalyst materials. The other photocatalyst material can include, for example: (1) metal oxides, metal nitrides, metal sulfides, metal sulphates, metal phosphates, metal oxynitrides, and metal oxysulfides in which the metals are chosen from B, Mg, Al, Si, Ca, Sc, Ti, V, Cr, Mn, Fe, Co, Ni, Cu, Zn, Ga, Ge, As, Sr, Y, Zr, Nb, Mo, Tc, Ru, Rh, Pd, Ag, Cd, In, Sn, Sb, Te, Ba, La, Hf, Ta, W, Re, Os, Ir, Pt, Au, Hg, Ti, Pb, Bi, Po; (2) III-V semiconductors where group III is B, Al, Ga, In and V is N, P, As, Sb; (3) II-VI semiconductors where group II is Zn, Cd, Hg and VI is Se and Te; (4) Group IV semiconductors which C, Si, Ge, Sn and their combinations; (5) Group VI semiconductors which S, Se, Te and their combinations; and/or (6) Perovskite (M₁M₂Oₓ) where M₁ is Na, Sr, Ba, K, Li, Re, La, Pb, Ca, Rb, Cs, Pd, Bi, Y, Mg, and M₂ is Ti, V, Cr, Fe, Mn, Cu, Co, Ag, Ni, Ta, Nb, W, Mo, Re, and Zr. In accordance with an exemplary embodiment, x is preferably 2.5-3.5, for example, 3 in M₁M₂Oₓ.

In accordance with an exemplary embodiment, the photoanode can made of a material selected from a group consisting of TiO₂, ZnO and other II-VI compounds (ZnO, ZnS, ZnSe, CdS, CdSe), and/or perovskite materials including M′M″O₃ where M″ is Ti (for example LiTiO₃ and NaTiO₃). For example, the photoanode can include a combination of TiO₂ mixed with ZnO, other II-VI compounds (ZnO, ZnS, ZnSe, CdS, CdSe), and/or perovskite materials, and where the perovskite is M′M″O₃ where M″ is Ti (for example, LiTiO₃ and NaTiO₃). In accordance with an exemplary embodiment, the TiO₂ to ZnO weight ratio can be up to 50%, for example, for a 1:1 ratio. In addition, a range of TiO₂ to other II-VI compounds, for example, ZnO, ZnS, ZnSe, CdS, CdSe can be 0 wt %-50 wt %, for example, 11 wt %, 15 wt %, and 26 wt %.

In accordance with another exemplary embodiment, a metal ion solar battery (MISB) or proton solar battery (PSB) is disclosed, which includes a solar panel-shaped stack (or tile shape) comprising a substrate, an electrode, a cathode, an electrolyte, a photoanode, a transparent electrode, and a transparent substrate. The cathode can be common cathode materials for metal ion or proton batteries.

### Fabrication Process for Prototype Energy Storage Device

In accordance with an exemplary embodiment, the prototype energy storage device may be fabricated through the process described above and shown in FIG. 2. The prototype energy storage device is based on a two-electrode system, similar to generic Li-ion batteries. In accordance with an exemplary embodiment, the anode is made of a photo-absorbing material, for example, an oxide of titanium or TiO₂, deposited on a transparent fluorine-doped tin oxide (FTO) electrode. For example, 0.2 g of TiO₂ nanoparticles powder (P25) can be mixed with 0.43 ml of 6 wt % PVDF binding polymer in NMP solution and 0.025 g of Super P. The mixture is diluted with 0.8 ml NMP and stirred for 12 hours. The slurry is casted on the FTO by doctor blading. The fabrication of the photoanode can be completed, for example, with a thermal treatment at 120° C. In accordance with an exemplary embodiment, the photoanode is predominantly titanium dioxide (TiO₂), for example, the photoanode after casting and sintering can be at least 90% titanium dioxide. In accordance with an exemplary embodiment, for example, the carbon additive in the photoanode can be from 0 wt % to 30 wt %, and more preferably to 10 wt % or less.

The slurry for the cathode fabrication can be prepared, for example, by mixing 0.4 g of LFP powder, 0.05 g of Super P and 0.85 ml of 6 wt % polyvinylidene fluoride (PVDF) in NMP solution, and diluted with 0.4 ml NMP. As shown in step 210, the cathode is doctor blading coated from the slurry on the FTO and heat treated at 120° C. In step 220, the energy storage device is fabricated by sandwiching the photoanode and cathode with, for example, by Surlyn hot melting film with a thickness of 60 μm. In addition, to a Surlyn hot melting film other material or method to seal the edges can be used (e.g., silicon bond, epoxy bond) and is not limited to the Surlyn film. The hot melting film seals the borders of the sandwich structure, and the middle of the sandwich should be filled with the electrolyte. Electrolyte injection can be through the hole on the hot melting film or transparent electrode surface, for example, inside a glovebox. In accordance with an exemplary embodiment, in step 230, for example, 0.33 M lithium bis(oxalato)borate (LiBOB) in propylene carbonate (PC) or 1.0 M lithium bis(trifluoromethanesulfonyl)imide (LiTFSI) in propylene carbonate (PC) can be used as the electrolyte, which is injected to the gap between two electrodes to complete the fabrication of the prototype energy storage device. In accordance with an exemplary embodiment, the electrolyte can be any carbonate-based electrolytes can be acceptable for the energy storage system or solar battery. For example, the electrolyte can be 1M LiBOB-PC-DEC, 1M LiTFSI-PC, 1M LiTFSI-PC-DEC.

### Operation of Solar Charging Battery

In accordance with an exemplary embodiment, the photo-charging process of the metal-ion solar battery (MISB) based on lithium-ion is as follows:
1) At the photoanode

Li⁺+Ti(IV)O₂+hv→LiTi(III)O₂+h⁺
2) At the cathode

LiFe(II)PO₄+h⁺→Fe(III)PO₄+Li⁺

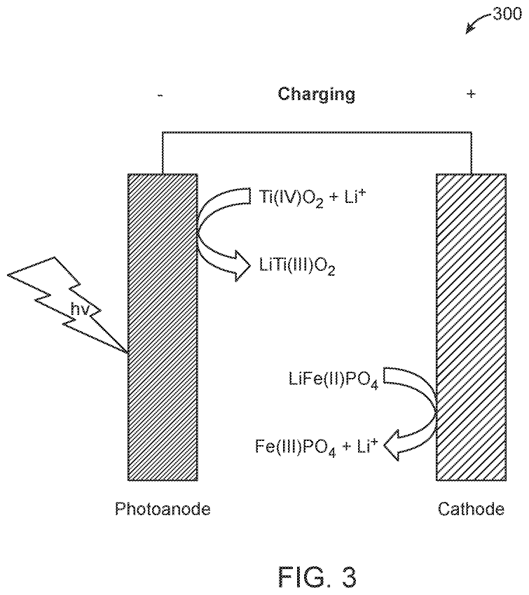

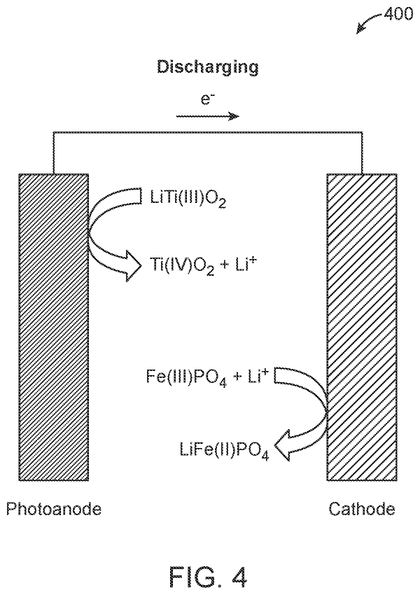

In accordance with an exemplary embodiment, through the above process, during charging the Li from the cathode is stored in the photoanode to charge the battery 100. The discharging is through the opposite process. The charging process and the discharging process of the solar battery, for example, are illustrated in FIGS. 3 and 4, respectively.

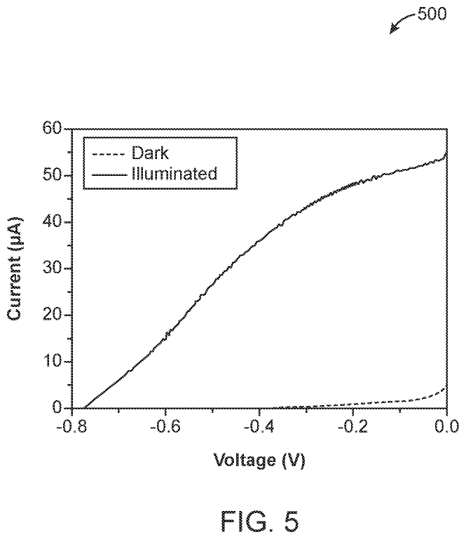

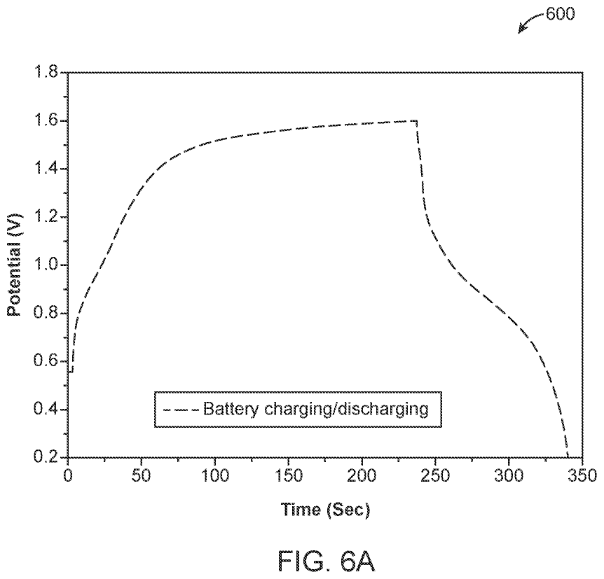

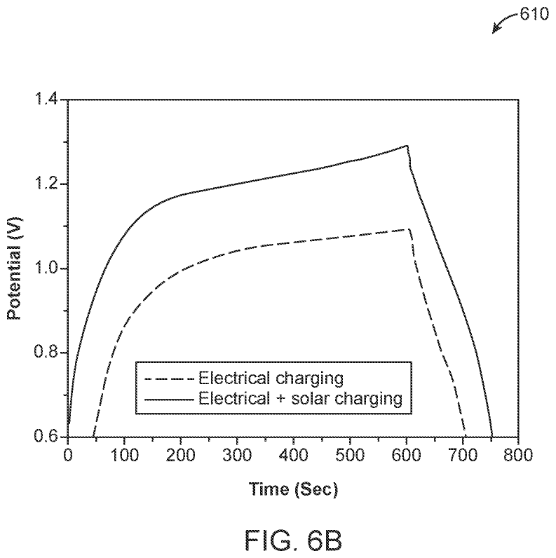

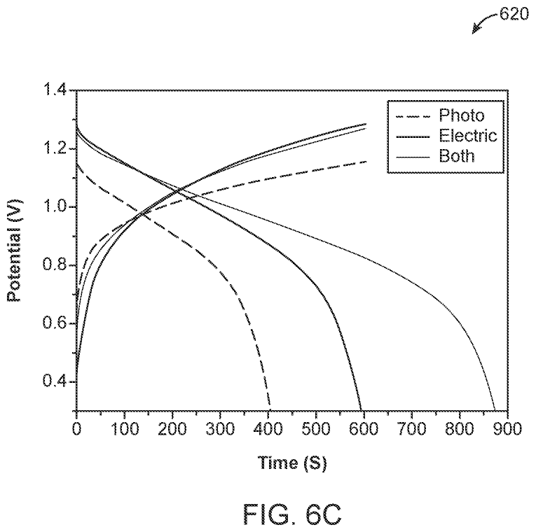

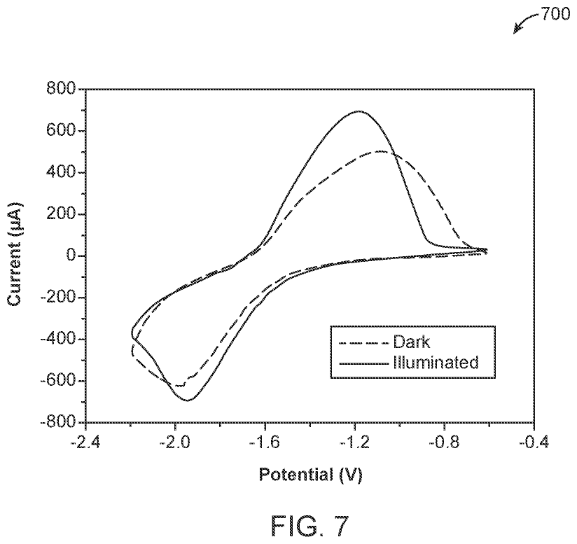

In accordance with an exemplary embodiment, the operation of the fabricated energy storage device showing behavior as a solar cell and a battery are shown in FIGS. 5A-6C. FIG. 5 shows the I-V curve measurement both in the dark and under light, and for a solar cell device, in the dark there is no generation of electricity. When the solar battery is exposed to light, FIG. 5 shows that the solar battery generates electricity via the photovoltaic effect. FIG. 6A shows that the energy storage device has a battery can be charged and discharged via an external power device (applying/withdrawing electrical current). FIG. 6B shows that the solar battery charging/discharging voltage and energy capacity can be increased (e.g. boosted) when expose to light. Moreover, when the energy storage device is charged electrically using an external charger under illumination, the charging rate and potential are increased by 25% and 20%, respectively, as shown in FIG. 6B. Thus, the energy storage device shows simultaneously characteristics of a solar cell and battery such that the photoanode (TiO₂), can play a dual role by 1) boosting charging by generating electrons in the TiO₂ electrode under light, and 2) allow for the charging and discharging characteristics of a Li-ion battery, by lithiation and delithiation. In addition, without light, the solar battery cannot produce the same result despite the application of voltage bias to increase voltage, because there is no reaction taking place at the TiO₂ electrode for the generation of holes and electrons. The boost is the result of the photovoltaic effect.

In accordance with an exemplary embodiment, the metal ion solar battery (MISB) 100 works as a solar cell, a battery, and a solar cell+battery integrated system. For example, as shown in FIGS. 5, 6A, and 6C, the MISB 100 can generate electricity by light illumination like a regular solar PV cell. In addition, as shown in FIG. 6C, the MISB 100 can be charged by light illumination as a solar PV and battery integrated system. In addition, the MISB 100 can be charged by electricity through an external power source as a regular battery, and the MISB 100 can be charged by both electricity and light illumination for boosted working voltage and charging rate. In accordance with an exemplary embodiment, the MISB can be used as a standalone self-powered system (off-grid), grid-connected, or microgrid system. For example, the microgrid operation allows the solar battery to be grid-connected, but when there is a grid failure (e.g., blackout) the system can island (disconnect) to provide support to electrical loads and resynchronized (reconnect) when the grid is back online.

In accordance with an exemplary embodiment, the MISB 100 can have a relatively seamless high-level integrated simple structure, which includes a cathode, an electrolyte, and a photoanode structure that is elegant, straight-forward, and relatively easy to fabricate. In addition, the relatively seamless integrated MISB can be relatively easy to install allowing for the efficient utilization of real estate. Furthermore, the MISB can be made from safe and low-cost material with a scalable manufacturing process. For example, no explosive materials were used. In addition, the MISB can be fabricated mostly under the unrestricted ambient environment.

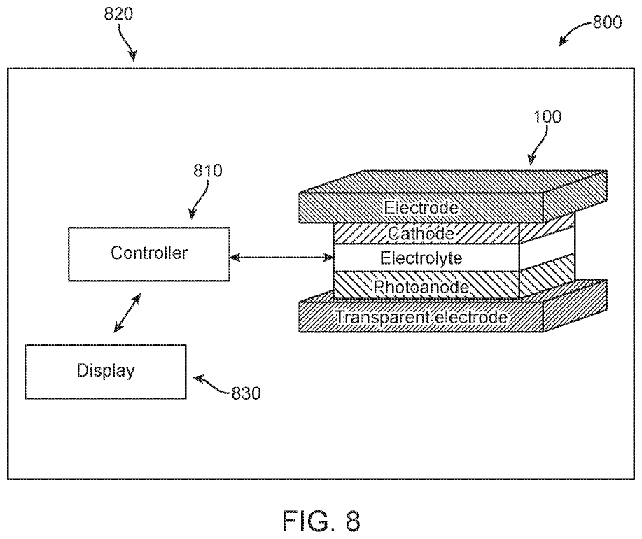

FIG. 8 is an illustration of a power generation device 800 in accordance with an exemplary embodiment. As shown in the FIG. 8, the power generation device 800 includes a metal ion solar battery (MISB) or proton solar battery (PSB) 100 and a micro-power conversion controller 810, which are preferably encased in a housing 820. In accordance with an exemplary embodiment, the energy storage device 100 includes a TiO₂ photoanode arranged beneath a transparent electrode 150 as shown in FIG. 1, and described herein. The micro-power conversion controller 810 can be configured to control the energy storage device 100 to deliver power under load, recharge the energy storage device 100, for example, when not under fully rated load and when the transparent electrode 110 of the energy storage device 100 is exposed to sufficient light, or grid power when power is available and doing so is beneficial (e.g. lower energy price, surplus grid power production, support grid stability, etc.). For example, grid power can be an interconnected network that delivers electricity from producers to consumers.

In addition, for example, the micro-power conversion controller 810 can be configured to: convert direct current (DC) to alternating current (AC); convert alternating current (AC) to direct current (DC); control charging and discharging of the energy storage device; optimize power production of the energy storage device; and/or control, monitor, report data for collection and analytics of the energy storage device by communication, for example, with an energy management platform.

In accordance with an exemplary embodiment, the micro-power conversion controller 810 may execute embodiments of the present disclosure, or portions thereof, may be implemented as computer-readable code executed on a processor or microprocessor. For example, the controller unit or device as discussed herein may be a single processor, a plurality of processors, or combinations thereof. It will be apparent to persons having skill in the relevant art that such processes result in the micro-power conversion controller 810 being a specially configured processor uniquely programmed to perform the functions discussed above. The power generation device 800 may also include an external display 830 for interfacing with a micro-power conversion controller 810 to execute, for example, programming of the power generation device to control and monitor data collection and analytics of the energy storage device by communication the energy storage device. For example, the external display 830 can be any suitable type of display for displaying data transmitted including a liquid crystal display (LCD), light-emitting diode (LED) display, capacitive touch display, thin-film transistor (TFT) display, and web connected devices including computers, laptops, tablets, cell phones, etc.

In various embodiments, for example, the micro-power conversion controller (MPCC) is an integrated 4-in-1 device solution, composed of a micro-optimizer, -inverter, -controller, and -communications for the solar battery technology. The MPCC is to perform optimal DC to AC power conversion, power output control, connectivity, monitoring and analysis via a web platform that is internet-connected. The MPCC is analogous to integrating into a single power device solutions for the solar energy industry to convert power at the panel level (microinverter), achieve optimal power output (optimizer), and control charging of a solar plus battery system (charge controller) and web-based connectivity for communications, control and analytics. The code refers to the control algorithms that will allow the implementation of different energy management strategies, including but not limited to: 1) emergency backup, 2) peak shaving, 3) load shifting, 4) load leveling, 5) self-consumption, 6) demand response, 7) grid support, and 8) market participation.”

In accordance with an exemplary embodiment, the energy storage device 100 can be configured to be charged by a light source, an external power source, or both the light source and the external power source simultaneously. In addition, the energy storage device 100 can be configured using the micro-power conversion controller 800 to function in a grid-connected mode, an off-grid mode, and/or a micro-grid mode. In accordance with an exemplary embodiment, the energy storage device 100 uses Li⁺, Na⁺, K⁺, Rb⁺, Cs⁺, and Fr⁺ or a proton solar battery using H⁺ as charge carrier. In accordance with an exemplary embodiment, the charge carrier is one of the component (mostly ionic) in the electrolyte, which carries the charge during operation. In case of the Li-based solar battery, one electrolyte that is widely used is LiPF₆. In the LiPF₆ electrolyte solution, there are Li⁺ and PF₆⁻ ions. Li⁺ is the main charge carrier in this case. So in this context, the charge carrier means the cations such as Li⁺, H⁺, Na⁺, and so. For example, the charge carrier is the ion (Li-ion), which is one of the components in the electrolyte (LiPF₆), but the electrolyte is the transport medium specific to the ion (charge carrier).

In accordance with an exemplary embodiment, the energy storage device 100 may be a non-alkali battery, the non-alkali battery including alkali earth metals (Mg²⁺, Ca²⁺) or transition metals (Zn²⁺) or other metals (Al³⁺). For example, the energy storage device is not limited to the alkali-based materials. In case of Li-based battery, all the components are related to Li, which means it comprises of Li carrier, Li source, and Li storage medium in the device. In addition, the working principle of Li-based battery can also be expanded to non-alkali-based batteries, too. In case of non-alkali batteries, for example, the major components of the battery—cathode, anode, and electrolyte are alkali earth or transition metal related materials. For example, the alkali earth metals can be Be, Mg, and Ca, and the transition metals can be Sc, Ti, V, Cr, Mn, Fe, Co, Ni, Cu, and Zn.

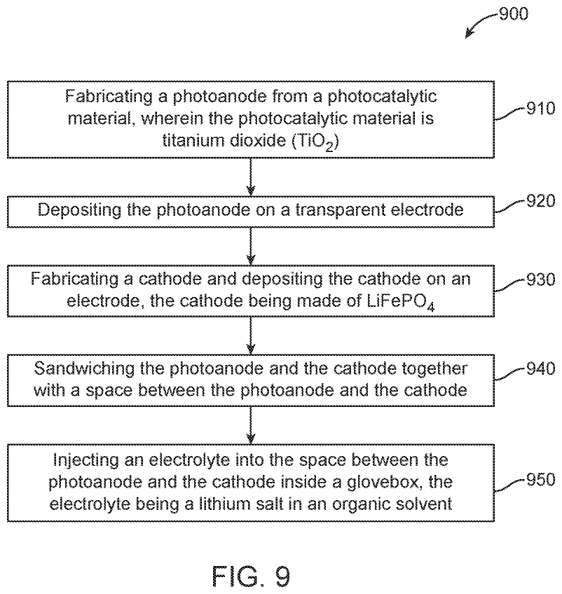

FIG. 9 is a flow chart 900 illustrating a fabrication process for an energy storage device in an unrestricted atmospheric environment in accordance with an exemplary embodiment by choosing materials that are safe and stable, for example, in an open-air environment. For example, the materials as disclosed herein are not susceptible to oxygen and humidity with the exception of the electrolyte. As shown in FIG. 9, the process for fabrication of a rechargeable energy storage device includes in step 910, fabricating a photoanode from a photocatalytic material, and wherein the photocatalytic material is titanium dioxide (TiO₂). In step 920, the photoanode is deposited on a transparent electrode. In step 930, a cathode made of LiFePO₄ is fabricated and the cathode is deposited on an electrode. In step 940, the photoanode and the cathode are sandwiched together with a space between the photoanode and the cathode. In step 950, an electrolyte is injected into the space between the photoanode and the cathode inside a glovebox, the electrolyte being, for example, lithium bis(oxalato)borate (LiBOB) or lithium bis(trifluoromethanesulfonyl)imide (LiTFSI). In accordance with an exemplary embodiment, in step 950, the electrolyte can be, for example, a combination of lithium salts such as LiTFSI and LiBOB in solvents such as PC and DEC. Various combinations of electrolytes such as 0.33M LiBOB-PC, 0.33M LiBOB-PC-DEC, 1M LiBOB-LiTFSI-PC, 1M LiBOB-PC, 1M LiBOB-PC-DEC, 1M LiTFSI-PC, 1M LiTFSI-PC-DEC can be used. For example, 2 wt % of LiBOB can be used as an additive to electrolyte for a stable solid electrolyte interphase (SEI) formed by reaction between LiBOB and carbonate solvent on electrode.

In accordance with an exemplary embodiment, the method further includes adjusting a crystal structure, a morphology, and/or a physical dimension of the titanium dioxide photoanode. In accordance with an exemplary embodiment, the titanium dioxide photoanode can be fabricated with anatase, rutile, brookite, amorphous, and/or other crystal structures of titanium dioxide (TiO₂). The titanium dioxide photoanode can be fabricated with stacked nanoparticles, hollow-shell structures, nanowires, nanorods, thin-films and/or any other morphology can be used for the photoanode.

In accordance with an exemplary embodiment, the transparent electrode is an indium-doped tin oxide (ITO), fluorine-doped tin oxide (FTO), or other transparent conducting film, and the method further includes depositing the photoanode on the transparent electrode via direct crystal growth or slurry coating from a mixture of titanium dioxide (TiO₂) nanocrystals and a binding polymer. The cathode can be made of LiMOₓ, LiFePO₄, LiCoO₂, or other common cathode materials, and the method further includes depositing the cathode on the electrode by slurry coating. In accordance with an exemplary embodiment, the electrolyte has Li⁺ as a main charge carrier.

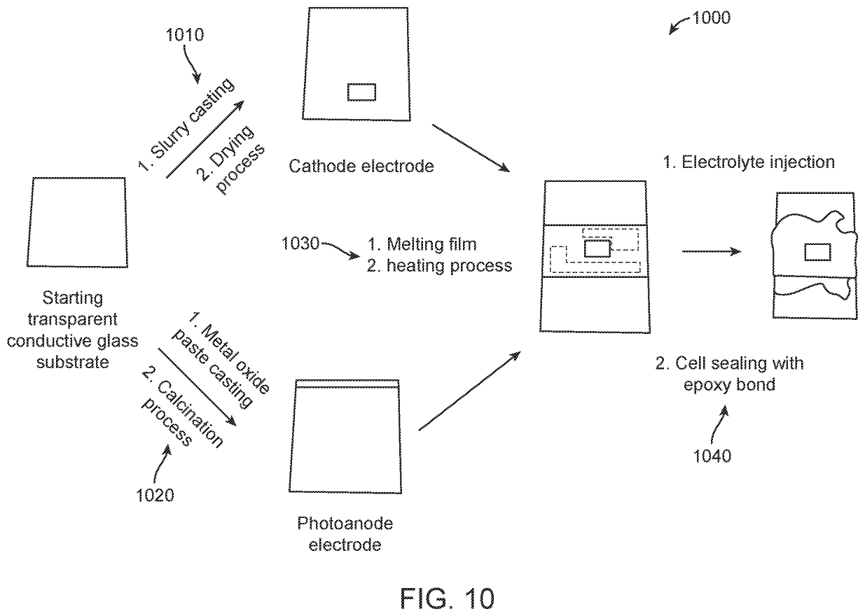

FIG. 10 is an illustration of another fabrication process 1000 in a mostly unrestricted atmospheric environment in accordance with an exemplary embodiment. As shown in FIG. 10, the process starts with transparent conductive glass substrate. In step 1010, a slurry casting as disclosed herein, for example, on a regular electrode and a drying process is performed to fabricate the cathode electrode. In step 1020, a metal oxide paste casting and calcination process is performed to fabricate the photoanode electrode as disclosed herein. In steps 1030 and 1040, the energy storage device is fabricated with a hot melting film and heating process as disclosed herein. In step 1040, an electrolyte is injected between the cathode and the photoanode and sealed inside a glovebox, for example, with an epoxy bond.

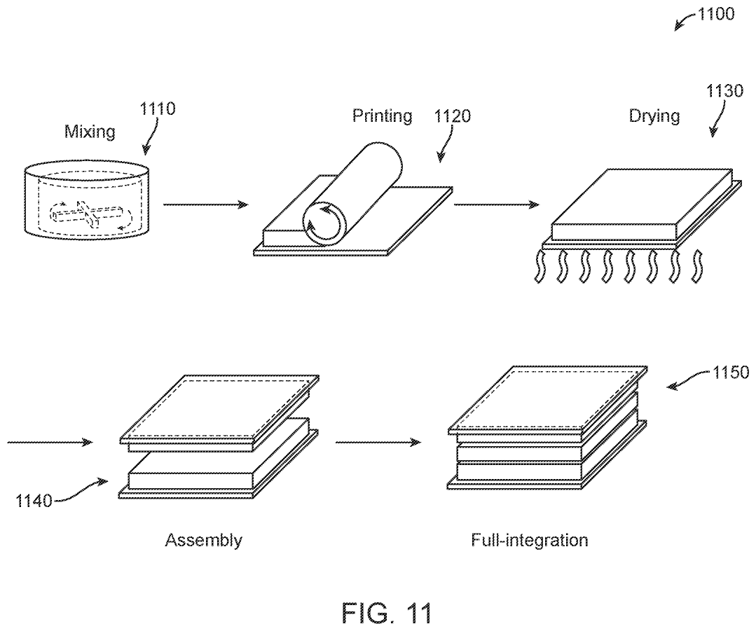

FIG. 11 is an illustration of another fabrication process 1100 in a mostly unrestricted atmospheric environment in accordance with an exemplary embodiment. As shown in FIG. 11, the process 1100 as disclosed herein includes a mixing process (1100), a printing process (1120), a drying process (1130), an assembly process (1140), and full-integration (1150).

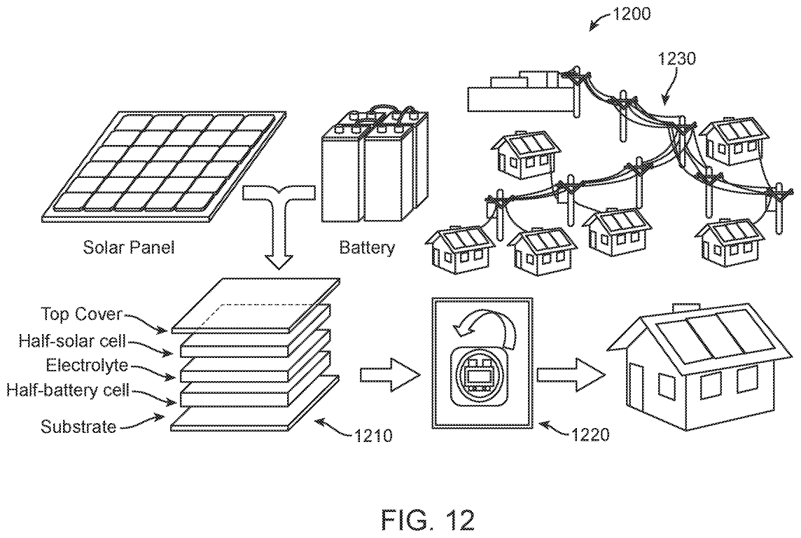

FIG. 12 is an illustration of the energy storage device and use in accordance with an exemplary embodiment. As shown in FIG. 12, the energy storage device 1210 can be incorporated, for example, solar panels 1220, which can be used as a standalone self-powered system (off-grid), grid-connected 1230, or microgrid system. For example, the microgrid operation allows the energy storage device to be grid-connected 1230, but when there is a grid failure (e.g., blackout) the system can island (disconnect) to provide support to electrical loads and resynchronized (reconnect) when the grid is back online.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A rechargeable electrochemical energy storage device comprising:
a photoanode.

2. The energy storage device according to claim 1, wherein the photoanode is an oxide of titanium.

3. The energy storage device according to claim 2, wherein the oxide of titanium is titanium dioxide (TiO2), and the photoanode is at least 90% titanium dioxide (TiO2) after casting and sintering.

4. The energy storage device according to claim 1, wherein the photoanode is fabricated with anatase, rutile, brookite, amorphous, and/or other crystal structures of titanium dioxide (TiO2).

5. The energy storage device according to claim 1, wherein the photoanode is fabricated with stacked nanoparticles, hollow-shell structures, nanowires, nanorods, thin-films, and/or any other morphology.

6. The energy storage device according to claim 1, wherein the photoanode is made of a material selected from a group consisting of TiO2 or other photocatalyst materials comprising:
metal oxides, metal nitrides, metal sulfides, metal sulphates, metal phosphates, metal oxynitrides, and metal oxysulfides in which the metals are chosen from B, Mg, Al, Si, Ca, Sc, Ti, V, Cr, Mn, Fe, Co, Ni, Cu, Zn, Ga, Ge, As, Sr, Y, Zr, Nb, Mo, Tc, Ru, Rh, Pd, Ag, Cd, In, Sn, Sb, Te, Ba, La, Hf, Ta, W, Re, Os, Ir, Pt, Au, Hg, Ti, Pb, Bi, Po;
III-V semiconductors where group III is B, Al, Ga, In and V is N, P, As, Sb;
II-VI semiconductors where group II is Zn, Cd, Hg and VI is Se and Te;
Group IV semiconductors which C, Si, Ge, Sn and their combinations;
Group VI semiconductors which S, Se, Te and their combinations; and/or
perovskite (M1M2Ox) where M1 is Na, Sr, Ba, K, Li, Re, La, Pb, Ca, Rb, Cs, Pd, Bi, Y, Mg, and M2 is Ti, V, Cr, Fe, Mn, Cu, Co, Ag, Ni, Ta, Nb, W, Mo, Re, and Zr.

7. The energy storage device according to claim 6, wherein the x in the perovskite (M1M2Ox) is 2.5 to 3.5.

8. A rechargeable electrochemical energy storage device, the storage device comprising:
a solar panel-shaped stack (or tile shape) comprising a substrate, an electrode, a cathode, an electrolyte, a photoanode, a transparent electrode, and a transparent substrate.

9. The energy storage device according to claim 8, wherein the cathode contains an alkali metal ion, a non-alkali ion, or a proton.

10. (canceled)

11. (canceled)

12. A power generation device comprising:
a rechargeable electrochemical energy storage device including a photoanode arranged beneath a transparent electrode; and
a micro-power conversion controller configured to control delivery of power under rated load, and recharge the rechargeable electrochemical energy storage device and when the transparent electrode is exposed to sufficient light and/or grid power is available.

13. The power generation device according to claim 12, wherein the photoanode comprises an oxide of titanium.

14. The power generation device according to claim 12, wherein the micro-power conversion controller is configured to:
convert direct current (DC) to alternating current (AC);
convert alternating current (AC) to direct current (DC);
control charging and discharging of the rechargeable electrochemical energy storage device;
optimize power production of the rechargeable electrochemical energy storage device; and/or
control, monitor, and perform data collection and analytics of the rechargeable electrochemical energy storage device.

15. The power generation device according to claim 12, wherein the rechargeable electrochemical energy storage device is configured to be charged by a light source, an external power source, or both the light source and the external power source simultaneously.

16. The power generation device according to claim 12, wherein the rechargeable electrochemical energy storage device uses using Li+, Na+, K+, Rb+, Cs+, and Fr+ or a proton rechargeable electrochemical energy storage device using H+ as charge carrier.

17. The power generation device according to claim 12, wherein the rechargeable electrochemical energy storage device is a non-alkali battery, the non-alkali battery including alkali earth metals (Mg2+, Ca2+), transition metals (Zn2+), or other metals (Al3+).

18. The power generation device according to claim 12, further comprising:
a display panel and web connected devices configured to interact with the micro-power conversion controller.

19. A method for fabrication of a rechargeable electrochemical energy storage device in a mostly unrestricted atmospheric environment, the method comprising:
fabricating a photoanode from a photocatalytic material, wherein the photocatalytic material is titanium dioxide (TiO2);
depositing the photoanode on a transparent electrode;
fabricating a cathode and depositing the cathode on an electrode, the cathode being made of LiFePO4;
sandwiching the photoanode and the cathode together with a space between the photoanode and the cathode; and
injecting an electrolyte into the space between the photoanode and the cathode in a glovebox, the electrolyte being a lithium salt in an organic solvent.

20. The method according to claim 19, wherein the lithium salt in the organic solvent is lithium bis(oxalato)borate (LiBOB) in propylene carbonate (PC) or lithium bis(trifluoromethanesulfonyl)imide (LiTFSI) in propylene carbonate (PC).

21. The method according to claim 19, wherein the transparent electrode is an indium-doped tin oxide (ITO), fluorine-doped tin oxide (FTO), or other transparent conducting film, the method further comprising:
depositing the photoanode on the transparent electrode via direct crystal growth or slurry coating from a mixture of titanium dioxide (TiO2) nanocrystals and a binding polymer.

22. The method according to claim 19, comprising:
depositing the cathode on the electrode by slurry coating.

23. The method according to claim 19, wherein the electrolyte has L+ as a main charge carrier.
